(19) United States
(12) Patent Application Publication
(10) Pub. No.: US 2011/0038441 A1
(43) Pub. Date: Feb. 17, 2011

(54) TRANSMISSION MODE DETECTION

(75) Inventor: Wei SHI, Cambridge (GB)

Correspondence Address: BLANK ROME LLP, WATERGATE, 600 NEW HAMPSHIRE AVENUE, N.W., WASHINGTON, DC, 20037, US

(73) Assignee: Cambridge Silicon Radio Limited, Cambridge (GB)

(21) Appl. No.: 12/540,238

(22) Filed: Aug. 12, 2009

(51) Int. Cl. H04L 27/06

(52) U.S. Cl. 375/340

(57) ABSTRACT

A method of detecting if a transmitted signal was transmitted in a particular transmission mode, the method comprising receiving a signal in primary and secondary frequency bands and comparing a first part of a header of the signal in the primary frequency band with a corresponding first part of a header of the signal in the secondary frequency band.

### FIELD OF THE INVENTION

The present invention relates to a method of detecting if a transmitted signal was transmitted in a particular transmission mode, to a computer program for performing the method and to apparatus for detecting if a transmitted signal was transmitted in a particular transmission mode.

### DESCRIPTION OF RELATED ART

The IEEE 802.11n standard for wireless communications defines a standard for wireless communications using an Orthogonal Frequency Division Multiplexing (OFDM) modulation scheme. Under this scheme an inverse fast Fourier transform (IFFT) is used to modulate complex digital data onto equally spaced frequency tones contained within frequency bands or channels which each have a bandwidth of 20 MHz.

The IEEE 802.11n standard defines three data packet formats or transmission modes, which are illustrated schematically in FIG. 1. The first of these formats is a non high throughput (Non-HT) format 10, and has a header containing a short training field (L-STF) 12 containing training data which can be used for synchronisation purposes, a long training field (L-LTF) 14 and a signal field (L-SIG) 16. A data field (DATA) 18 follows the signal field 16.

The second packet format is a high throughput mixed mode (HT-MM) format 20, which has a header containing a short training field (L-STF) 22, a long training field (L-LTF) 24, a signal field (L-SIG) 26 and a high throughput signal field (HT-SIG1) 28.

The third format is a high throughput green field (HT-GF) format 30, which has a header containing a short training field (L-STF) 32, a high throughput long training field (HT-LTF1) 34, a high throughput signal field (HT-SIG1) 36 and a second high throughput signal field (HT-SIG2) 38.

The IEEE 802.11n standard specifies that a Non-HT wireless station (such as a fixed wireless access point or a mobile telephone, for example) can only transmit and receive non-HT data packets. A high throughput (HT) wireless station can transmit and receive non-HT and HT-MM data packets and optionally HT-GF data packets.

Under the IEEE 802.11n standard data is transmitted using multiple sub-carriers within 20 MHz channels. For HT wireless stations, the standard optionally permits data transmissions in which two adjacent channels, known as a primary channel and a secondary channel, are combined to form a 40 MHz channel. In the HT-MM and HT-GF modes this increased bandwidth results in a higher data rate, whilst in the non-HT mode the same data is transmitted simultaneously on both channels, giving rise to a transmission mode known as Non-HT Duplicate Mode. Non-HT wireless stations can only transmit in 20 MHz channels and cannot receive HT-MM and HT-GF transmissions from 40 MHz capable HT stations. A 40 MHz capable HT station can transmit and receive 20 MHz data packets.

Data exchange between two stations in a wireless network made up of multiple wireless stations is subject to interference from other stations in the network. A station may be a fixed wireless access point, or may be a mobile wireless device such as a portable computer or mobile telephone. In order to reduce the likelihood of such interference arising, control frames are typically used to reserve the channel used to transfer the data between a transmitter and a receiver to ensure that other stations in the network do not transmit on that channel during the data exchange, so as to reduce the possibility of interference from other stations in the network. Prior to transmitting data a transmitter broadcasts a Request to Send (RTS) message which can be detected by stations in the vicinity of the transmitter. The intended receiver of the data to be transmitted responds to the RTS message with a Clear to Send (CTS) message. The CTS message informs other stations in the vicinity of the receiver that they should not transmit during the data transmission, and data transmission from the transmitter to the receiver commences once this response has been received by the transmitter.

In a network containing both HT and non-HT stations, control frames are also used to protect HT transmissions. This is necessary because non-HT stations may not understand transmissions originating from HT stations and may thus cause interference with an HT transmission by transmitting during the HT transmission.

The IEEE 802.11n standard states that where a control frame is transmitted in a 40 MHz combined channel the intended receiver station should respond using a control frame in the same 40 MHz combined channel. This ensures that non-HT and HT 20 MHz only stations in the network can be notified of the impending 40 MHz combined channel transmission; if the response were transmitted in only the primary channel, for example, stations in the wireless network operating in the secondary channel may not receive the response and thus may continue to transmit during the data transmission between the transmitter and the receiver, leading to interference with the transmission. Similarly, if the response were transmitted using only the secondary channel, stations operating in the primary channel may not receive the response and may thus continue to transmit during the data transmission between the transmitter and the receiver.

A wireless station cannot distinguish between non-HT transmissions in a single 20 MHz channel and a Non-HT Duplicate mode transmission in a combined 40 MHz channel by decoding the information in the signal field of the header alone. Thus, a 40 MHz capable HT station may detect a non-HT 20 MHz signal from a non-HT station and interpret the signal as having been transmitted in Non-HT Duplicate mode, causing the HT station to respond with a 40 MHz combined band signal, which could interfere with signals transmitted by other stations in the network.

### SUMMARY OF THE INVENTION

According to a first aspect of the present invention there is provided a method of detecting if a transmitted signal was transmitted in a particular transmission mode, the method comprising receiving a signal containing signal components in primary and secondary frequency bands and comparing a first part of a header of the signal component in the primary frequency band with a corresponding first part of a header of the signal component in the secondary frequency band.

The method of the first aspect of the present invention facilitates the rapid detection of a particular signal transmission mode, thereby allowing a receiving entity to make appropriate adjustments to its performance or other characteristics at an early stage. In particular, the method permits the Non-HT Duplicate mode to be detected, thereby allowing an HT station to detect quickly whether a received transmission will be in that mode, and to respond appropriately to minimise the risk of interference with other stations. Additionally, this early detection of the Non-HT Duplicate mode allows the HT station to configure itself to make the most effective use possible of the received signal, for example by combining the duplicate data signals to enhance data reception quality.

Comparing the first part of the header of the signal component in the primary frequency band with the corresponding first part of the header of the signal component in the secondary frequency band may comprise calculating a metric indicative of a level of similarity between the first part of the header of the respective signal components, the metric being compared to a threshold to determine if the transmitted signal was transmitted in the particular transmission mode.

Calculating the metric may comprise calculating a cross-correlation of the first part of the header of the signal component in the primary frequency band and the corresponding first part of the header of the signal component in the secondary frequency band.

The first part of the signal component in the primary frequency band and the first part of the signal component in the secondary frequency band may comprise signal fields of the respective signals.

The method may further comprise calculating a metric indicative of the power of a second part of the header of the signal component in the secondary frequency band and comparing the metric so calculated to a threshold to determine whether the transmitted signal was transmitted in both the primary and secondary frequency bands.

The threshold may be based upon a metric indicative of the power of a second part of the header of the signal component in the primary frequency band, said second part of the header of the signal component in the primary frequency band corresponding to the second part of the signal component in the secondary frequency band.

The second part of the header of the signal component in the primary frequency band and the corresponding second part of the header of the signal component in the secondary frequency band may comprise training sequence fields of the respective signal components.

The primary and secondary frequency bands may be adjacent one another in frequency.

The transmitted signal is preferably a signal transmitted in accordance with the IEEE 802.11n standard and the particular transmission mode is Non-HT Duplicate mode.

According to a second aspect of the invention there is provided a computer program for performing the method of the first aspect.

According to a third aspect of the invention there is provided apparatus for determining whether a transmitted signal was transmitted in a particular transmission mode, the apparatus comprising a receiver for receiving a signal containing signal components in primary and secondary frequency bands and a processor for comparing a first part of a header of the signal component in the primary frequency band with a corresponding first part of a header of the signal component in the secondary frequency band.

The processor may be configured to calculate a metric indicative of a level of similarity between the first parts of the headers of the respective signal components, and to compare the metric to a threshold to determine if the transmitted signal was transmitted in the particular transmission mode.

The processor may be configured to calculate a cross-correlation of the first part of the header of the signal component in the primary frequency band and the corresponding first part of the header of the signal component in the secondary frequency band.

The first part of the signal component in the primary frequency band and the first part of the signal component in the secondary frequency band may comprise signal fields of the respective signal components.

The processor may be configured to calculate a metric indicative of the power of a second part of the header of the signal component in the secondary frequency band and to compare the metric so calculated to a threshold to determine whether the transmitted signal was transmitted in both the primary and secondary frequency bands

The threshold may be based upon a metric indicative of the power of a second part of the header of the signal component in the primary frequency band, said second part of the header of the signal component in the primary frequency band corresponding to the second part of the signal component in the secondary frequency band.

The second part of the header of the signal component in the primary frequency band and the corresponding second part of the header of the signal component in the secondary frequency band may comprise training sequence fields of the respective signal components.

The primary and secondary frequency bands may be adjacent one another in frequency.

The transmitted signal is preferably a signal transmitted in accordance with the IEEE 802.11n standard and the particular transmission mode is Non-HT Duplicate mode.

According to a fourth aspect of the present invention there is provided a method of assessing whether a transmitted signal was transmitted in primary and secondary frequency bands, the method comprising receiving a signal containing signal components in primary and secondary frequency bands, calculating a metric indicative of the power of a part of a header of the signal component in the secondary frequency band and comparing the metric so calculated to a threshold to determine whether the transmitted signal was transmitted in both the primary and secondary frequency bands

The threshold may be based upon a metric indicative of the power of a part of a header of the signal component in the primary frequency band, said part of the header of the signal component in the primary frequency band corresponding to the part of the signal component in the secondary frequency band.

The part of the header of the signal component in the primary frequency band and the corresponding part of the header of the signal component in the secondary frequency band may comprise training sequence fields of the respective signal components.

The primary and secondary frequency bands may be adjacent one another in frequency.

The transmitted signal is preferably a signal transmitted in accordance with the IEEE 802.11n standard and the particular transmission mode is Non-HT Duplicate mode.

According to a fifth aspect of the invention there is provided a computer program for performing the method of the fourth aspect.

According to a sixth aspect of the invention there is provided apparatus for assessing whether a transmitted signal was transmitted in primary and secondary frequency bands, the apparatus comprising a receiver for receiving a signal containing signal components in the primary and secondary frequency bands and a processor for calculating a metric indicative of the power of a part of a header of the signal component in the secondary frequency band and comparing the metric so calculated to a threshold to determine whether the transmitted signal was transmitted in both the primary and secondary frequency bands

The threshold may be based upon a metric indicative of the power of a part of a header of the signal component in the primary frequency band, said part of the header of the signal component in the primary frequency band corresponding to the part of the signal component in the secondary frequency band.

The part of the header of the signal component in the primary frequency band and the corresponding part of the header of the signal component in the secondary frequency band may comprise training sequence fields of the respective signal components.

The primary and secondary frequency bands may be adjacent one another in frequency.

The transmitted signal is preferably a signal transmitted in accordance with the IEEE 802.11n standard and the particular transmission mode is Non-HT Duplicate mode.

### BRIEF DESCRIPTION OF THE DRAWINGS

Embodiments of the invention will now be described, strictly by way of example only, with reference to the accompanying drawings, of which:

FIG. 1 is a schematic representation of three data packet formats defined in the IEEE 802.11n standard; and

FIG. 2 is a schematic representation of a receiver architecture according to an embodiment of the present invention.

### DETAILED DESCRIPTION OF THE PREFERRED EMBODIMENT

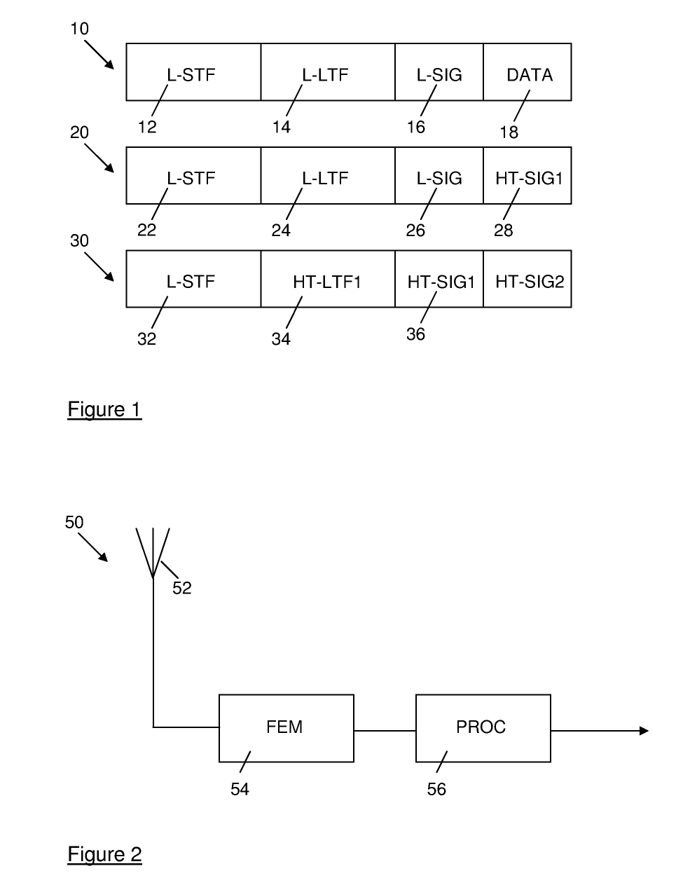

Referring firstly to FIG. 1, an HT receiver architecture is shown generally at 50. It will be appreciated that the receiver architecture 50 is a schematic representation only, and the functional blocks illustrated do not necessarily correspond to actual physical components of a receiver. Moreover, for reasons of clarity and brevity, only those components that are relevant to the present invention are illustrated in FIG. 2.

The HT receiver 50 has an antenna 52 which is capable of receiving signals in the 2.4/5.0 GHz frequency band used by the IEEE 802.11n standard. Specifically, the receiver 50 is capable of receiving signals containing signal components in primary and secondary channels of 20 MHz bandwidth within the 2.4/5.0 GHz operating frequency band used by the IEEE 802.11n standard. The antenna 52 is connected to a front end module 54, which performs functions such as synchronisation and timing calculation. The front end module 54 has an output which is connected to a processor 56, which is configured to detect whether a signal received by the receiver 50 was transmitted using the Non-HT Duplicate mode defined in the IEEE 802.11n standard, as will be described below. The processor 56 has an output which passes the received signal to downstream components for further processing. However, as these components are not relevant to the embodiments of the present invention they are not shown in FIG. 2 and will not be described in detail here.

A 40 MHz capable HT wireless station can transmit and receive data using a combined 40 MHz channel made up of two adjacent 20 MHz channels, or using a single 20 MHz channel. Each channel contains a plurality of individual frequency tones onto which data is modulated using an OFDM modulation scheme, as described above. Thus, a signal received by the HT receiver 50 may have been transmitted using either a 40 MHz combined channel or a single 20 MHz channel. Where the received signal was transmitted using a 40 MHz combined channel, it may have been transmitted using one of the three transmission modes described above and illustrated in FIG. 1.

When a signal is received by the HT receiver 50 it is not known whether the signal was transmitted in a single primary 20 MHz channel or whether it was transmitted in a 40 MHz combined channel made up of the primary channel and an adjacent secondary channel. Even if the received signal was transmitted using a single 20 MHz primary channel it is possible that a wireless station other than the nominal transmitting station transmitted a signal on the adjacent secondary channel which would have been used to make up the 40 MHz combined channel. Thus, it is necessary to analyse the received signal to detect the transmission mode of the received signal.

The front end module 54 processes the received signal to determine timing information, synchronisation and the like, typically on the basis of the short training field 12, 22, 32 of the received signal. The front end module then passes the received signal, which may contain signal components in the primary and secondary channels, on to the processor 56 which detects whether the received signal was transmitted using the Non-HT Duplicate mode.

The processor 56 assumes that the received signal contains signal components in the primary and secondary channels, and separates the received signal into the primary and secondary channel signal components. The processor 56 processes these components to detect whether the received signal was transmitted using Non-HT Duplicate mode.

In a first step, the processor 56 determines whether a signal has been received in the secondary channel at all. The processor 56 calculates the power of the long training field 14, 24, 34 of the primary channel component of the received signal. It is important to note that regardless of the transmission mode used to transmit the received signal the long training field occupies the same position in the header of the primary and secondary channel components of the received signal. Thus, provided that the synchronisation and timing information is correctly decoded by the front end module 54, the processor 56 can always perform this power calculation for the primary channel.

The HT-MM and non-HT transmission modes use 52 sub-carriers in the long training field 14, 24. Each sub-carrier consists of a training symbol. The HT-GF mode long training field 34 uses the same 52 sub-carriers with four additional sub-carriers, giving 56 sub-carriers, each sub-carrier consisting of a training symbol. To calculate the power of the long training field, the processor 56 performs a fast Fourier transform (FFT) on the received long training field symbol of the primary channel to extract data from the sub-carriers. The power P_{Pr} of the long training field of the primary channel is calculated by summing the power of the 52 sub-carriers, as follows:

$${P}_{Pr} = {\sum }_{k = 1}^{52} {\vert {y}_{Pr}^{k} \vert}^{2}$$

where y_{Pr}^{k} is the FFT output on the kth sub-carrier.

The processor 56 then calculates the power of the long training field of the secondary channel component of the received signal in the same manner. Thus, the processor 56 performs an FFT on the received symbols of the long training field of the secondary channel to extract data from the sub-carriers. The power P_{Sec} of the long training field of the secondary channel is calculated by summing the power of the 52 FFT outputs corresponding to the 52 sub-carriers, as follows:

$${P}_{Sec} = {\sum }_{k = 1}^{52} {\vert {y}_{Sec}^{k} \vert}^{2}$$

where y_{Sec}^{k} is the FFT output on the kth sub-carrier.

It will be noted that although the long training field of the HT-GF mode contains 56 sub-carriers, only 52 sub-carriers are used to calculate the power of the long training field. This is because an acceptable indication of the power can be achieved using only these sub-carriers of the long training field. Of course, where the transmission mode is non-HT or HT-MM, all 52 of the sub-carriers of the long training field are used to calculate the power of the long training field.

The processor 56 then calculates a metric N by dividing the power of the long training field of the primary channel by a power of 2, as follows:

$$N = \frac{{P}_{Pr}}{M}$$

where M is a power of two integer.

The metric N is used as a threshold against which the power of the long training field of the secondary channel is compared by the processor 56. If the power of the long training field of the secondary channel exceeds this threshold the processor 56 deems that a signal has been received in the secondary channel and proceeds to a second step.

In the second step the processor 56 calculates a metric indicative of the similarity between data in the signal fields 16, 26, 36 of the headers of the received primary and secondary channel signal components, to ascertain whether duplicate data has been transmitted in the primary and secondary channels. If duplicate data has been transmitted in the primary and secondary channels it can be inferred that the transmission was made using either Non-HT Duplicate mode or HT-MM 40 MHz mode.

The processor 56 calculates a metric R by performing a cross-correlation between the data in the signal fields of the headers of the received primary and secondary channel signals, as follows:

$$R = {\sum }_{k = 1}^{52} {s}_{Pr}^{k} \cdot {s}_{sec}^{k}$$

where s_{Pr}^{k} is the demodulated symbol output on the kth sub-carrier of the signal field of the received primary channel signal and s_{Sec}^{k} is the demodulated symbol output on the kth sub-carrier of the signal field of the received secondary channel signal.

The signal fields of the headers in all three of the transmission modes available to an HT station contain 52 sub-carriers. Each sub-carrier is modulated with data that can take one of only two values. For example, where each sub-carrier is modulated with a single bit of data, the value of the data may be ±1. Thus, the calculation by the processor 56 of the metric R is relatively straightforward. In the example above where data on the sub-carriers of the signal field of the received primary and secondary channel signals can take only the values ±1, the maximum value of R is +52 whilst the minimum value of R is −52. It is possible, however, to use more than two values for s_{Pr}^{k} and s_{Sec}^{k} so as to provide a level of reliability for each demodulated symbol.

In the HT-GF transmission mode data in the high throughput signal field 36 of the header (which takes the same position in the header as the signal fields 16, 26 of the Non-HT mode and HT-GF mode) is rotated by 90 degrees with respect to data in the equivalent signal fields of the non-HT and HT-MM transmission formats. Thus, if the signal was transmitted using the HT-GF transmission mode the value of R will be low.

The processor 56 compares the metric R to a threshold Th. If R is greater than Th, the processor 56 deems that the received signal was transmitted in either Non-HT Duplicate mode or in HT-MM 40 MHz mode. In order to detect which of these two modes was used to transmit the received signal the processor 56 must inspect the following symbol 18, 28 of the header of the received signal. If a data symbol 18 is detected the processor 56 deems that the signal was transmitted using Non-HT Duplicate mode, whereas if a HT-SIG1 28 symbol is detected the processor 56 deems that the received signal was transmitted using HT-MM 40 MHz mode. The detection of a data symbol 18 or a HT-SIG1 symbol 28 is common to all receivers capable of receiving transmissions under the IEEE 802.11n standard and techniques for detecting these symbols will be familiar to those skilled in the relevant art.

The value of Th may be predetermined on the basis of a-priori knowledge of channel conditions and the like. Alternatively the processor 56 may calculate the value of Th dynamically. The value of Th affects the detection rate for transmissions made using Non-HT Duplicate mode. If Th is too high, the sensitivity of the receiver 50 to Non-HT Duplicate mode transmissions is reduced, meaning that the receiver may not detect such transmissions. On the other hand, if Th is too low there may be false detections of Non-HT Duplicate mode. It is important to minimise the rate of false detection of Non-HT Duplicate mode, since if the receiver 50 detects this mode it will respond to an RTS with a 40 MHz combined channel signal. In the event that the RTS was transmitted by a non-HT wireless station (i.e. using only a primary 20 MHz channel) this 40 MHz response could interfere with transmissions made by other stations in the network operating in the secondary channel.

It will be appreciated by those skilled in the art that a metric indicative of the similarity between data in the signal fields of the received primary and secondary channel signals can be calculated in a number of ways, of which calculating the cross-correlation R of the data in the respective signal fields is merely one example.

It will also be appreciated that although in the exemplary embodiment described above the processor 56 performs first and second steps sequentially, these steps could equally be performed independently of one another.

The exemplary embodiment described above uses a processor executing a suitable program to process the received signal. It will be appreciated, however, that embodiments of the present invention can be implemented in a variety of ways, for example as a software program executing on a general purpose processor or computer, or as custom hardware such as a specifically-designed integrated circuit (IC) or an appropriately configured application specific integrated circuit (ASIC), field programmable gate array (FPGA) or digital signal processor (DSP).

While a preferred embodiment has been set forth above, those skilled in the art who have reviewed the present specification will readily appreciate that other embodiments can be realized within the scope of the invention, which should therefore be construed as limited only by the appended claims.

What is claimed is:

1. A method of detecting if a transmitted signal was transmitted in a particular transmission mode, the method comprising receiving a signal containing signal components in primary and secondary frequency bands and comparing a first part of a header of the signal component in the primary frequency band with a corresponding first part of a header of the signal component in the secondary frequency band.

2. A method according to claim 1 wherein comparing the first part of the header of the signal component in the primary frequency band with the corresponding first part of the header of the signal component in the secondary frequency band comprises calculating a metric indicative of a level of similarity between the first part of the header of the respective signal components, the metric being compared to a threshold to determine if the transmitted signal was transmitted in the particular transmission mode.

3. A method according to claim 2 wherein calculating the metric comprises calculating a cross-correlation of the first part of the header of the signal component in the primary frequency band and the corresponding first part of the header of the signal component in the secondary frequency band.

4. A method according to claim 1 wherein the first part of the signal component in the primary frequency band and the first part of the signal component in the secondary frequency band comprise signal fields of the respective signals.

5. A method according to claim 1 further comprising calculating a metric indicative of the power of a second part of the header of the signal component in the secondary frequency band and comparing the metric so calculated to a threshold to determine whether the transmitted signal was transmitted in both the primary and secondary frequency bands

6. A method according to claim 5 wherein the threshold is based upon a metric indicative of the power of a second part of the header of the signal component in the primary frequency band, said second part of the header of the signal component in the primary frequency band corresponding to the second part of the signal component in the secondary frequency band.

7. A method according to claim 6 wherein the second part of the header of the signal component in the primary frequency band and the corresponding second part of the header of the signal component in the secondary frequency band comprise training sequence fields of the respective signal components.

8. A method according to claim 1 wherein the primary and secondary frequency bands are adjacent one another in frequency.

9. A method according to claim 1 wherein the transmitted signal is a signal transmitted in accordance with the IEEE 802.11n standard and the particular transmission mode is Non-HT Duplicate mode.

10. A computer program for performing the method of claim 1.

11. Apparatus for determining whether a transmitted signal was transmitted in a particular transmission mode, the apparatus comprising a receiver for receiving a signal containing signal components in primary and secondary frequency bands and a processor for comparing a first part of a header of the signal component in the primary frequency band with a corresponding first part of a header of the signal component in the secondary frequency band.

12. Apparatus according to claim 11 wherein the processor is configured to calculate a metric indicative of a level of similarity between the first parts of the headers of the respective signal components, and to compare the metric to a threshold to determine if the transmitted signal was transmitted in the particular transmission mode.

13. Apparatus according to claim 12 wherein the processor is configured to calculate a cross-correlation of the first part of the header of the signal component in the primary frequency band and the corresponding first part of the header of the signal component in the secondary frequency band.

14. Apparatus according to claim 11 wherein the first part of the signal component in the primary frequency band and the first part of the signal component in the secondary frequency band comprise signal fields of the respective signal components.

15. Apparatus according to claim 11 wherein the processor is configured to calculate a metric indicative of the power of a second part of the header of the signal component in the secondary frequency band and to compare the metric so calculated to a threshold to determine whether the transmitted signal was transmitted in both the primary and secondary frequency bands

16. Apparatus according to claim 15 wherein the threshold is based upon a metric indicative of the power of a second part of the header of the signal component in the primary frequency band, said second part of the header of the signal component in the primary frequency band corresponding to the second part of the signal component in the secondary frequency band.

17. Apparatus according to claim 16 wherein the second part of the header of the signal component in the primary frequency band and the corresponding second part of the header of the signal component in the secondary frequency band comprise training sequence fields of the respective signals.

18. Apparatus according to claim 11 wherein the primary and secondary frequency bands are adjacent one another in frequency.

19. Apparatus according to claim 11 wherein the transmitted signal is a signal transmitted in accordance with the IEEE 802.11n standard and the particular transmission mode is Non-HT Duplicate mode.

20. A method of assessing whether a transmitted signal was transmitted in primary and secondary frequency bands, the method comprising receiving a signal containing signal components in primary and secondary frequency bands, calculating a metric indicative of the power of a part of a header of the signal component in the secondary frequency band and comparing the metric so calculated to a threshold to determine whether the transmitted signal was transmitted in both the primary and secondary frequency bands

21. A method according to claim 20 wherein the threshold is based upon a metric indicative of the power of a part of a header of the signal component in the primary frequency band, said part of the header of the signal component in the primary frequency band corresponding to the part of the signal component in the secondary frequency band.

22. A method according to claim 21 wherein the part of the header of the signal component in the primary frequency band and the corresponding part of the header of the signal component in the secondary frequency band comprise training sequence fields of the respective signal components.

23. A method according to claim 20 wherein the primary and secondary frequency bands are adjacent one another in frequency.

24. A method according to claim 20 wherein the transmitted signal is a signal transmitted in accordance with the IEEE 802.11n standard and the particular transmission mode is Non-HT Duplicate mode.

25. A computer program for performing the method of claim 20

26. Apparatus for assessing whether a transmitted signal was transmitted in primary and secondary frequency bands, the apparatus comprising a receiver for receiving a signal containing signal components in the primary and secondary frequency bands and a processor for calculating a metric indicative of the power of a part of a header of the signal component in the secondary frequency band and comparing the metric so calculated to a threshold to determine whether the transmitted signal was transmitted in both the primary and secondary frequency bands

27. Apparatus according to claim 26 wherein the threshold is based upon a metric indicative of the power of a part of a header of the signal component in the primary frequency band, said part of the header of the signal component in the primary frequency band corresponding to the part of the signal component in the secondary frequency band.

28. Apparatus according to claim 27 wherein the part of the header of the signal component in the primary frequency band and the corresponding part of the header of the signal component in the secondary frequency band comprise training sequence fields of the respective signal components.

29. Apparatus according to claim 26 wherein the primary and secondary frequency bands are adjacent one another in frequency.

30. Apparatus according to claim 26 wherein the transmitted signal is a signal transmitted in accordance with the IEEE 802.11n standard and the particular transmission mode is Non-HT Duplicate mode.
